(19) United States
(12) Patent Application Publication
(10) Pub. No.: US 2026/0195190 A1
(43) Pub. Date: Jul. 9, 2026

(54) CORE UTILIZATION BASED RUNTIME ADAPTIVE OPERATION CONFIGURATION IN A MANY-CORE SYSTEM

(71) Applicant: Ampere Computing LLC, Santa Clara, CA (US)

(72) Inventors: Mahesh MADHAV, Portland, OR (US); Erika Susana Alcorta LOZANO, Pflugerville, TX (US); Raymond Scott TETRICK, Portland, OR (US); Scott WITSCHER, Portland, OR (US)

(21) Appl. No.: 19/014,026

(22) Filed: Jan. 8, 2025

(51) Int. Cl. G06F 9/50

(52) U.S. Cl. CPC G06F 9/5066; G06F 9/505

(57) ABSTRACT

Disclosed are techniques for runtime adaptive operation configuration in a many-core system. In an aspect, a method for runtime adaptive operation configuration in a many-core system includes performing a dynamic operation configuration, where the dynamic operation configuration includes determining a core utilization in the many-core system, determining an operation configuration based on the core utilization, and configuring at least one core in the many-core system according to the operation configuration. In some aspects, the dynamic operation configuration may be performed periodically or in response to a trigger condition.

### BACKGROUND

### I. Field of the Disclosure

Aspects of the disclosure relate generally to the management of multiple processor cores, and specifically to core utilization based runtime adaptive operation configuration in a many-core system.

### II. Background

Cloud data centers have memory, storage, and processing resources that are available to a consumer/customer via the Internet or another type of network. Many-core SoCs provide economies of scale to cloud data centers due to the fact that many-core SoCs can support large numbers of processes or processor threads in a compact and power-efficient package. The term “node” generally refers to a collection of such resources, and as used herein, the term “node” may refer specifically to one SoC or to a cluster of SoCs. Thus, a cloud data center typically has multiple nodes, which may be co-located together in one facility, distributed across disparate facilities (which themselves may or may not be geospatially diverse), or a combination of the above. A many-core SOC may have a number of operation configuration options, which are selected at boot time and not changeable thereafter.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for runtime adaptive operation configuration in a many-core system includes performing an operation configuration comprising: determining a processor core utilization in the many-core system; determining an operation configuration based on the processor core utilization; and configuring at least one processor core in the many-core system according to the operation configuration.

In an aspect, an apparatus for runtime adaptive operation configuration in a many-core system includes a plurality of processor cores; and control circuitry coupled to the plurality of processor cores and configured to perform an operation configuration comprising: determining a processor core utilization in the many-core system; determining an operation configuration based on the processor core utilization; and configuring at least one processor core of the plurality of processor cores according to the operation configuration.

In an aspect, an apparatus includes means for performing an operation configuration, comprising: means for determining a processor core utilization in a many-core system; means for determining an operation configuration based on the processor core utilization; and means for configuring at least one processor core in the many-core system according to the operation configuration.

In an aspect, a non-transitory computer-readable medium storing computer-executable instructions that includes computer-executable instructions that, when executed by the apparatus, cause the apparatus to determine a processor core utilization in a many-core system; computer-executable instructions that, when executed by the apparatus, cause the apparatus to determine an operation configuration based on the processor core utilization; and computer-executable instructions that, when executed by the apparatus, cause the apparatus to configure at least one processor core in the many-core system according to the operation configuration.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a graph illustrating the concept of “phase” as applied to program behavior, according to aspects of the disclosure.

FIG. 2 is a set of graphs showing the order of best performance of various runtime configurations at different core utilizations.

FIG. 3 is a diagram of a many-core system on a chip (SoC) that supports runtime adaptive operation configuration, according to aspects of the disclosure.

FIGS. 4A-4B are diagrams of a core in more detail, according to aspects of the disclosure.

FIG. 5 is a diagram of a generic event monitor (GEM), according to aspects of the disclosure.

FIG. 6 is a flowchart of an example process associated with runtime adaptive operation configuration in a many-core system, according to aspects of the disclosure.

FIG. 7 illustrates a method for runtime adaptive operation configuration in a many-core system, according to aspects of the disclosure.

FIG. 8 is a flow chart illustrating a process for runtime adaptive operation configuration in a many-core system, according to aspects of the disclosure.

### DETAILED DESCRIPTION OF THE DRAWINGS

Disclosed are techniques for runtime adaptive operation configuration in a many-core system. In an aspect, a method for runtime adaptive operation configuration in a many-core system includes periodically performing an operation configuration, where the operation configuration includes determining a core utilization in the many-core system, determining an operation configuration based on the core utilization, and configuring at least one core in the many-core system according to the operation configuration. In some aspects, determining the operation configuration comprises determining at least one of a prefetch configuration, a branch architecture configuration, or a microarchitecture configuration. In some aspects, determining a microarchitecture configuration comprises determining at least one of a dispatch width or a size of a front-end queue (FEQ).

Conventional processors may support multiple operation configuration options, but these are selected at boot time and not changeable thereafter. For example, hardware data prefetching can reduce memory latency and significantly improve the performance of many applications, provided it accurately and promptly detects their memory access patterns. Conventional processors may include multiple prefetcher components, each performing a particular prefetch methodology and/or targeting a particular application behavior, and may offer a mechanism by which the user may adjust (including enabling or disabling) prefetcher components through registers. In another example, conventional processors may support multiple branch prediction algorithms, and may offer a mechanism by which the user may select one of the supported branch prediction algorithms through other registers.

However, determining the optimal operation configuration is a challenging task. For example, determining when to enable or disable prefetcher components for any program application is difficult, in part because there may be non-linear performance behavior based on which combinations of prefetchers are enabled, since there is a tradeoff between accurate prefetches to improve latency and useless prefetches that consume system resources without providing a commensurate performance benefit (in some aspects, by consuming memory bandwidth, polluting cache(s), etc.). In a many-core (e.g., 40+ individual cores) environment, this becomes a first-order effect. The best prefetcher configuration can be highly dependent upon on the workload (e.g., the specific program or application) and its runtime characteristics (e.g., whether the code being executed at a particular instant is memory-intensive or processor-intensive).

Likewise, branch prediction can also reduce memory latency and significantly improve the performance of many applications, provided it accurately predicts which branch is taken. Branch prediction may be static or dynamic. Static branch prediction approaches include “always taken,” “always not taken,” “backward taken, forward not taken,” and others. Dynamic branch prediction approaches include “last time prediction,” “counter based prediction,” and others. Like prefetch configuration, the optimal branch prediction algorithm can be highly dependent upon the specific workload, e.g., with some types of programs benefiting from one branch prediction method and other types of programs benefiting from another branch prediction method.

The optimal microarchitecture configuration, including but not limited to microarchitecture configuration options such as front end queue (FEQ) size, dispatch width, and others, can also be highly dependent upon the specific workload. For example, the FEQ is a buffer which can be downsized using a control register. Reducing the size of the FEQ will limit the amount of speculation that happens during core execution. In some aspects, if the performance monitoring data indicates that too much speculation and not enough “good” work is happening, then the FEQ size can be reduced, which may result in more efficient execution. Under other circumstances, the FEQ can be restored to full size.

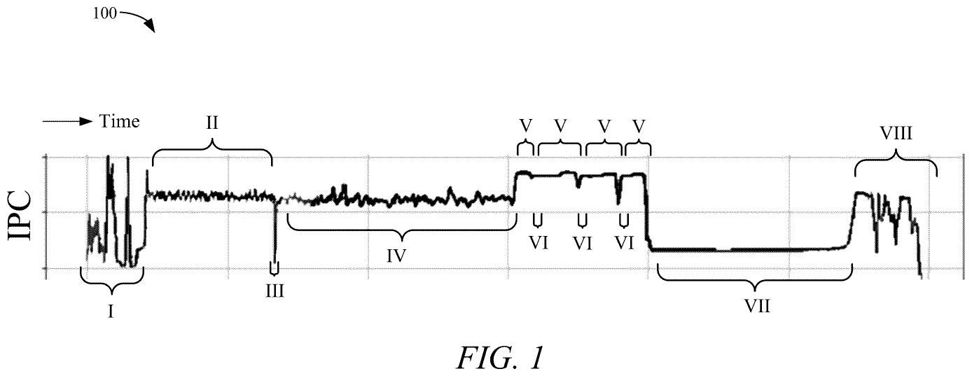

FIG. 1 is a graph 100 illustrating the concept of “phase” as applied to program behavior, according to aspects of the disclosure. FIG. 1 shows a graph of instructions per cycle (IPC) over time during execution of an example workload. In the example illustrated in FIG. 1, several different “phases” are identified, labeled with Roman numerals “I” through “VIII” on the graph. In the example illustrated in FIG. 6, phase I may be an initialization phase that is a mix of instruction and data caching, memory access, device configuration, and other startup tasks associated with a program. Phase II may represent main loop processing, with a fairly steady number of instructions executed per cycle. Phase III may represent a period during which the program may have been interrupted by another program or another core, for example. Phase IV may represent some kind of long calculation that involves occasional memory access. Phase V may represent a processor-intensive operation that is interspersed with I/O-intensive phases VI. Phase VII may represent another memory-intensive phase, and phase VIII may represent miscellaneous actions taken in preparation for program termination. The optimal operation configuration (prefetcher, branch prediction architecture, microarchitecture configuration, etc.) can depend on the current phase.

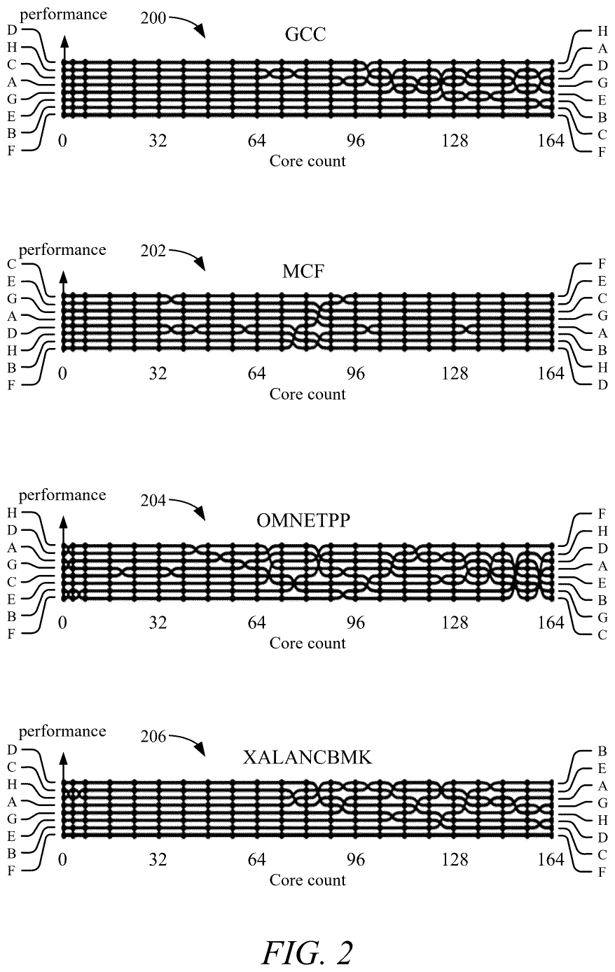

In addition, the optimal operation configuration (prefetcher, branch prediction architecture, microarchitecture configuration, etc.) can vary based on core utilization, which is defined as the number of active cores in a multi-core system. This is illustrated in FIG. 2.

FIG. 2 is a set of graphs showing the order of best performance of various runtime configurations at different core utilizations. In each graph, the performance of each of eight different operation configurations labeled A through H are shown, where a higher position on the Y axis indicates a bigger improvement. Each configuration represents a unique combination of prefetcher configuration, branch prediction architecture, and/or other operation configuration option. The core utilization is shown in the X axis, with data taken for active core counts of 1, 4, 8, and multiples of 8 thereafter. Each of the graphs 200, 202, 204, and 206 shows the performance of the runtime configurations A-H running a different benchmark: gcc (graph 200), mcf (graph 202), omnetpp (graph 204), and xalancbmk (graph 206).

Looking at graph 200, it can be seen that for active core counts of 64 and below, runtime configuration D shows the best performance while configuration F shows the worst performance. However, as the core count increases beyond 96 cores, the performance of runtime configuration D drops to third place, below runtime configuration H and runtime configuration A. At an active core count of 156, runtime configuration D drops to fifth place. Looking at graph 202, it can be seen that for this benchmark, runtime configuration F provides the lowest performance for 72 active cores, but very quickly jumps to first place for core counts of 96 and above. Graph 204 and graph 206 similarly illustrate the point that runtime configuration performance can vary based on core utilization alone, even if all cores are running the same benchmark.

Customers of multi-core products care about per-core performance, and specifically about per core performance at low core count or low utilization. For example, in a 192-core processor, there may be only 16 or 32 active cores, leaving the remaining idle; in that scenario, customers expect higher performance of their application as a result. The problem is that if the multi-core system is operationally configured to provide the best performance under full load, this does not necessarily mean best performance under partial load. This is illustrated in FIG. 2: as shown in graph 206, for example, operation configuration B provides the best performance for benchmark xalancbmk when all 164 cores are operating but provides the second worst performance if less than 128 cores are operating. For conventional multi-core systems, this is a problem because operation configuration can only be changed as part of a boot process.

Thus, in conventional systems, the user typically selects an operation configuration at boot time and hopes that they made the correct decision. If the user later decides to change the operation configuration, the user must reboot the system in order to change the operation configuration. While this is already disruptive for a single-core system, it is extremely disruptive for a many-core (and especially cloud-based) system, at least because the number of processes that must be terminated and restarted is a function of the number of cores in the system. Therefore, what is needed is runtime adaptive operation configuration in a many-core system.

Accordingly, methods and systems for runtime adaptive operation configuration in a many-core system are herein presented. In some aspects, a system for runtime adaptive operation configuration includes a plurality of processor cores, control circuitry for performing a control function, and a mesh interconnect communicatively coupled to the plurality of processor cores and the control circuitry. The control circuitry is configured to periodically perform an operation configuration, where the operation configuration includes determining a processor core utilization in the many-core system, determining an operation configuration based on the processor core utilization, and configuring at least one processor core of the plurality of processor cores according to the operation configuration. Core utilization refers to the number or percentage of active cores within a multi-core system. In some aspects, the criteria for what constitutes an active core may be adjustable. For example, in some aspects, a core may be considered “active” if the number of instructions that were retired within a time epoch of 100 ms exceeds a threshold value, e.g., 1,000,000. Other threshold values and/or other metrics may be used as the criteria for determining that a core is or is not active.

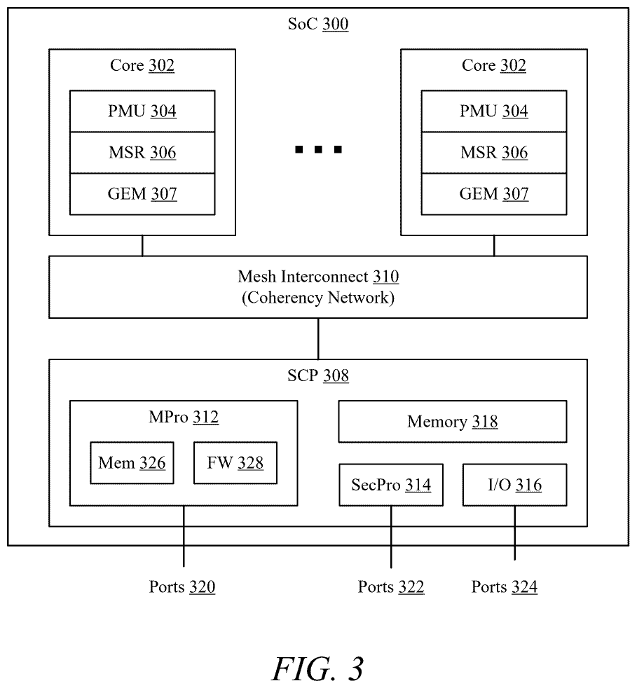

FIG. 3 is a diagram of a many-core system on a chip (SoC) 300 that supports runtime adaptive operation configuration, according to aspects of the disclosure. The SoC 300 illustrated in FIG. 3 includes a set of processing cores 302 (or simply “cores” 302). In the example illustrated in FIG. 3, each core 302 includes a performance monitoring unit (PMU) 304, at least one model-specific register (MSR) 306, and a generic event monitor (GEM) 307.

The PMU 304 may comprise several programmable registers that can be used to monitor micro-architectural information. Example events that a PMU 304 may track include, but are not limited to, the number of instructions, number of cycles, the number of memory accesses, the number of branch misses, and the number of cache misses. These numbers can be used to calculate features such as instructions per cycle (IPC), the number of memory accesses per 1 k instructions, the number of branch misses per 1 k instructions, the number of cache misses per 1 k instructions, the ratio of cache misses to memory accesses, the ratio of L2 data cache refills to cache misses, and the ratio of L2 instruction cache refills to branch misses.

The MSR 306 may comprise several programmable registers that can be used to control the behavior of one or more components of a core 302, including enabling or disabling each of a plurality of prefetcher modes of operation, which may include activating or deactivating each of a plurality of prefetcher circuits, selecting a branch prediction algorithm, activating or deactivating half-width execution, changing the FEQ size, and other operation configuration options.

The GEM 307 collects data associated with the activity of the core 302 in hardware and, in parallel, provides the collected data to firmware so that the firmware does not have to query each core 302 separately.

The SoC 300 also includes a system control processor (SCP) 308 that handles many of the system management functions of the SoC 300. The cores 302 are connected to the SCP 308 via a mesh interconnect 310 that forms a high-speed bus that couples each of core 302 to the other cores 302 and to other on chip and off-chip resources, including higher levels of memory (e.g., a level three (L3) cache, dual data rate (DDR) memory), peripheral component interconnect express (PCIe) interfaces, and/or other resources.

The SCP 308 may include a variety of system management functions, which may be divided across multiple functional blocks or which may be contained in a single functional block. In the example illustrated in FIG. 3, the system management functions of the SCP 308 are divided over a management processor (MPro) 312 and a security processor (SecPro) 314 coupled to other components of the SoC 300 by the mesh interconnect 310. The SoC 300, the MPro 312, and the SecPro 314 may each include joint test action group (JTAG) ports and firmware, which may be connected to other components within the SoC 300 via the mesh interconnect 310, an inter-integrated circuit (I2C) interface, or other connection.

In the example illustrated in FIG. 3, the SCP 308 further includes an input/output (I/O) block 316 and an on-board shared memory 318 also coupled to other components of the SoC 300 by the mesh interconnect 310. Note that although FIG. 3 illustrates the MPro 312 and the SecPro 314 as separate microcontrollers (or processors), as will be appreciated, they may be combined into one or two microcontrollers, or sub-divided into more than two microcontrollers.

The MPro 312 and the SecPro 314 may include a bootstrap controller and an I2C controller or other bus controller. The MPro 312 and the SecPro 314 may communicate with on-chip sensors, an off-chip baseboard management controller (BMC), and/or other external systems to provide control signals to external systems. The MPro 312 and the SecPro 314 may connect to one or more off-chip systems as well via ports 320 and ports 322, respectively, and/or may connect to off-chip systems via the I/O block 316, e.g., via ports 324. In the example shown in FIG. 3, the MPro 312 includes its own memory 326 and firmware 328 for performing some of its tasks independently of the processor cores 302, as will be discussed in more detail below.

The MPro 312 performs error handling and crash recovery for the cores 302 of the SoC 300 and performs power failure detection, recovery, and other fail safes for the SoC 300. The MPro 312 performs the power management for the SoC 300 and may connect to one or more voltage regulators (VR) that provide power to the SoC 300. The MPro 312 may receive voltage readings, power readings, and/or thermal readings and may generate control signals (e.g., dynamic voltage and frequency scaling (DVFS)) to be sent to the voltage regulators. The MPro 312 may also report power conditions and throttling to an operating system (OS) or hypervisor running on the SoC 300. The MPro 312 may provide the power for boot up and may have specific power throttling and specific power connections for boot power to the SCP 308 and/or the SecPro 314. The MPro 312 may receive power or control signals, voltage ramp signals, and other power control from other components of the SCP 308, such as the SecPro 314, during boot up as hardware and firmware become activated on the SoC 300. These power-up processes and power sequencing may be automatic or may be linked to events occurring at or detected by the MPro 312 and/or the SecPro 314. The MPro 312 may connect to the shared memory 318, the SecPro 314, and external systems (e.g., VRs) via ports 320, and may supply power to each via power lines.

In some aspects, the MPro 312 keeps track of how many cores are active, i.e., the core utilization. For example, in some aspects, the firmware 328 takes samples at 10 Hz, e.g., by reading data, stored in the memory 326 by the GEM block 307, that indicates how many instructions were committed by the core 302 in the time window. For example, in some aspects, if there are more than N instructions committed, the core 302 is marked as active and otherwise marked as inactive. In one embodiment, a core may be considered active if at least 1,000,000 instructions were committed within 100 ms (i.e., N=1,000,000). This value of N is illustrative and not limiting; other aspects may use other values of N.

The SecPro 314 manages the boot process and may include on-board read-only memory (ROM) or erasable programmable ROM (EPROM) for safely storing firmware for controlling and performing the boot process. The SecPro 314 also performs security sensitive operations and only runs authenticated firmware. More specifically, the components of the SoC 300 may be divided into trusted components and non-trusted components, where the trusted components may be verified by certificates in the case of software and firmware components, or may be pure hardware components, so that at boot time, the SecPro 314 may ensure that the boot process is secure.

The shared memory 318 may be on-board random-access memory (RAM) or secured RAM that can be trusted by the SecPro 314 after an integrity check or certificate check. The I/O block 316 may connect over ports 324 to external systems and memory (not shown) and connect to the shared memory 318. The SCP 308 may use the I/O connections of the I/O block 316 to interface with a BMC or other management system(s) for the SoC 300 and/or to the network of the cloud platform (e.g., via gigabit ethernet, PCIe, or fiber). The SCP 308 may perform scaling, balancing, throttling, and other control processes to manage the cores 302, associated memory controllers, and mesh interconnect 310 of the SoC 300.

In some aspects, the mesh interconnect 310 is part of a coherency network. There are points of coherency somewhere in the mesh network depending on the address and target memory. A coherency network typically includes control registers, status registers, and state machines, and in the example illustrated in FIG. 3, these are initialized by the MPro 312, e.g., based on system and memory configuration, and the MPro 312 monitors the coherency domain for errors.

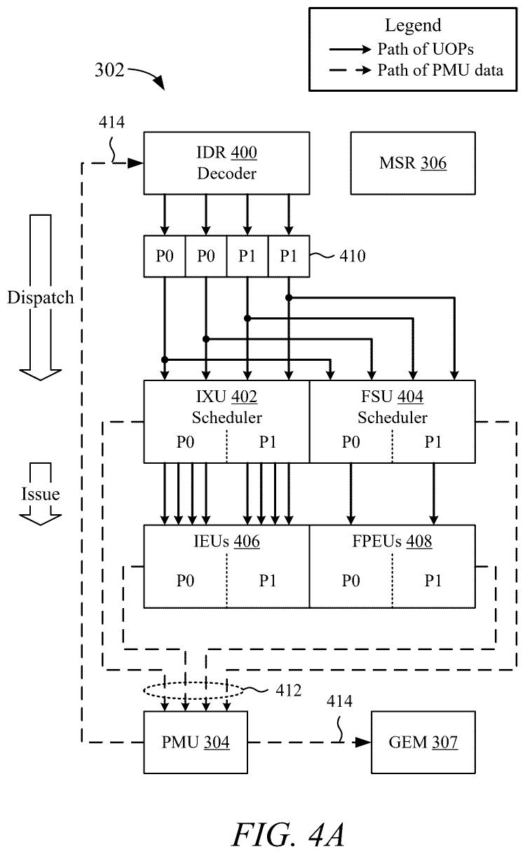

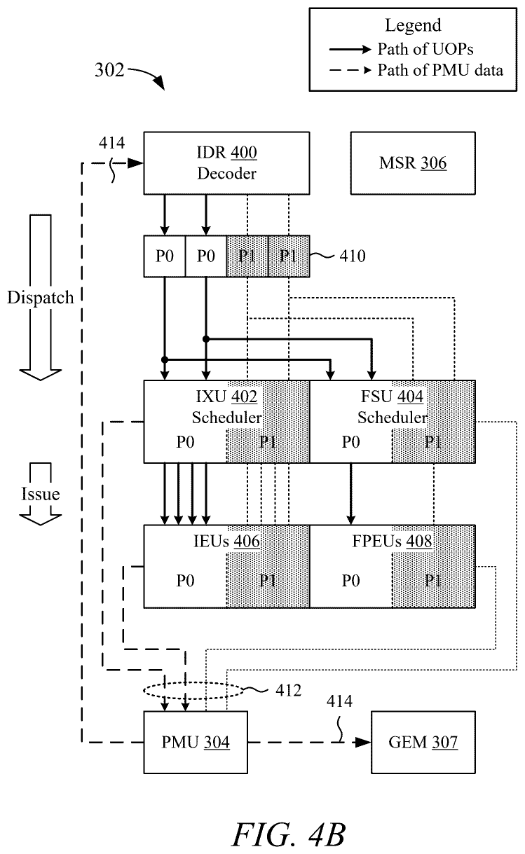

FIGS. 4A-4B are diagrams of a core 302 in more detail, according to aspects of the disclosure. FIG. 4A shows the core 302 operating in full-width dispatch mode, and FIG. 4B shows the core 302 operating in half-width dispatch mode. In the example shown in FIGS. 4A-4B, the core 302 includes an instruction decoder (IDR) 400, which dispatches micro-operations (UOPs) to either an integer scheduling unit (IXU) 402 or a floating point (FP) scheduling unit (FSU) 404. The IXU 402 issues integer UOPs to one of a block of integer execution units (IEUs) 406. The FSU 404 issues FP UOPs to one of a block of floating point execution units (FPEUs) 408. Other portions of the core 302 are omitted from FIGS. 4A-4B for clarity.

In some aspects, portions of the core 302 are divided into multiple partitions having identical functions. In the example illustrated in FIGS. 4A-4B, each of the IXU 402, the FSU 404, the IEUs 406 and the FPEUs 408 is divided into two partitions, labeled partition 0 (P0) and partition 1 (P1). In the example illustrated in FIG. FIGS. 4A-4B, the IDR 400 is a “four-wide” decoder, meaning that it can issue four UOPs simultaneously. In some aspects, two of the UOPs will be processed by P0 and two UOPs will be processed by P1. This is illustrated in FIGS. 4A-4B as four “lanes” 410, also labeled P0 or P1 depending on the destination partition. Alternatively, it can be said that each partition has its own pair of schedulers, i.e., one integer scheduler and one floating point scheduler.

In the example shown in FIGS. 4A-4B, during operation of the core 302, the PMU 304 can monitor micro-architectural information and event data, which may be referred to herein as “PMU data” 412, from one or more of the IXU 402, the FSU 404, the IEUs 406, and the FPEUs 408. In the example shown in FIGS. 4A-4B, the PMU 304 can provide PMU or other information 414 to the IDR 400 and the GEM 307. In some aspects, the MSR 306 can control the mode of operation of one or more of the IDR 400, IXU 402, FSU 404, IEUs 406, FPEUs 408, PMU 304, and GEM 307.

FIG. 4A illustrates full-width dispatch mode. As shown in FIG. 4A, during full-width dispatch mode, the IDR 400 puts a UOP in each of the four lanes 410. Using the two lanes labeled P0 for example, if both UOPs are integer UOPs, then both UOPs will be sent to partition P0 of the IXU 402. If both UOPs are floating point UOPs, then both UOPs will be sent to partition P0 of the FSU 404. If one UOP is an integer UOP and the other UOP is a floating point UOPs, then the integer is sent to partition P0 of the IXU 402 and the floating point UOP is sent to partition P1 of the FSU 404. The same principle applies to the two lanes labeled P1: integer UOPs in those lanes are sent partition P1 of the IXU 402 and floating point UOPs in those lanes are sent to partition P1 of the FSU 404. Dispatch occurs in program order (IO). The UOPs may be stored in a buffer or queue within a scheduler.

Issue can occur out-of-order (OOO). The IXU 402 and the FSU 404 can change the order that UOPs are executed as required by dependencies. In the example shown in FIG. 4A, the IXU 402 can simultaneously issue up to four integer UOPs each from P0 and P1, for a total of eight UOPs issued simultaneously to the IEUs 406. In the example shown in FIG. 4A, the FSU 404 can simultaneously issue up to two floating point UOPs to the FPEUs 408. In typical operation, however, the IXU 402 and FSU 404 will issue only to an available IEU 406 or FPEU 408, respectively, and if none are available, will wait until one becomes available. For example, a long-latency integer divide will occupy a single IEU 406 for seven cycles, and the IXU 402 will have to wait until the integer divide is complete before it can issue another integer UOP to that IEU 406. As a result, the IXU 402 and FSU 404 tend to not issue all eight integer UOPs and two floating point UOPs every cycle, even when dispatch occurs at its maximum rate.

FIG. 4B illustrates half-width dispatch mode, in which the P1 portions of the lanes 410, IXU 402, FSU 404, IEUs 406, and FPEUs 408 are unused and shaded to indicate such. As shown in FIG. 4B, during half-width dispatch mode, the IDR 400 puts a UOP into the P0 lanes 410 but not into the P1 lanes 410. Because the P1 lanes 410 are unused, the P1 section of the IXU 402 is unused, the P1 section of the FSU 404 is unused, the P1 section of the IEUs 406 is unused, and the P1 section of the FPEUs 408 is unused. In some aspects, the unused portions may be powered down. In some aspects, the unused portions maintain power but do not receive clock signals. In some aspects, signals to or from the unused portions may be interrupted, held at a static value, or disconnected. In the example shown in FIG. 4A, signal paths that are unused are shown as dotted lines.

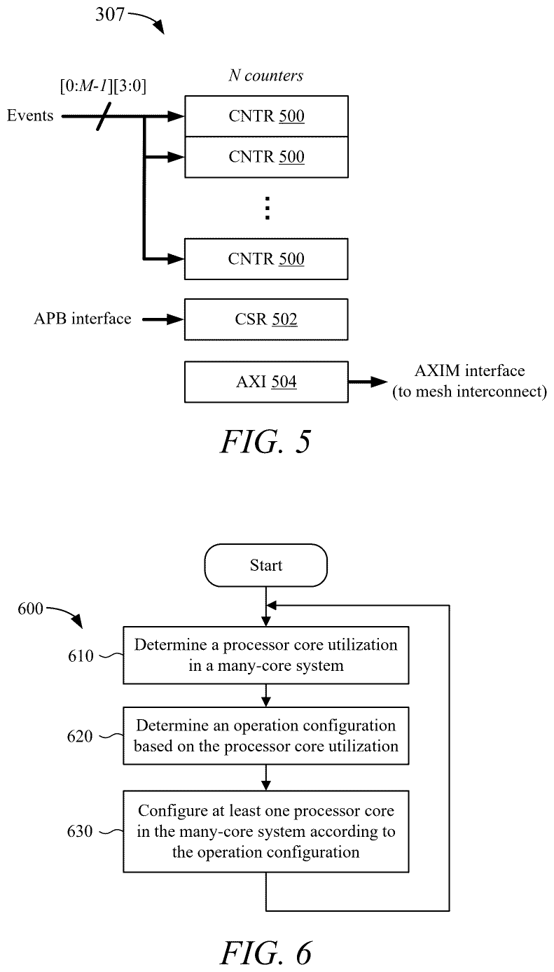

FIG. 5 is a diagram of a GEM 307 in more detail, according to aspects of the disclosure. In the example shown in FIG. 5, the GEM 307 includes N different event counters 500, each of which can be configured to count one of M different types of events. In the example shown in FIG. 3, each event is represented by four bits of data, but other data widths may be used instead. In the example shown in FIG. 3, the full set of events are available to each event counter, and the specific event to be counted by that counter is programmable. The number of counters N and the number of different event types M may vary according to the capabilities of the core being monitored and the needs of the entity doing the monitoring. In some aspects, each counter is a 24 bit counter (e.g., to be able to count up to 1 ms without overflow given a 4 GHz clock input), but other counter widths may be used instead. In some aspects, the GEM 307 may maintain a historical record of counter values for the last L number of epochs, which may be used, for example, to allow for some smoothing effects for the algorithms.

In the example shown in FIG. 5, the GEM 307 includes a command and status register (CSR) block 502, which is accessible via an internal bus, such as the Ampere peripheral bus (APB). In some aspects, the CSR block 502 hosts the control registers that control which counters are enabled or disabled and that control the assignment of event type(s) to counter(s). In the example shown in FIG. 5, the GEM 307 includes an advanced extensible interface (AXI) 504, which is used to push data to the data consumer, e.g., the MPro 312, via an AXI master (AXIM) interface.

FIG. 6 is a flowchart of an example process 600 associated with runtime adaptive operation configuration in a many-core system, according to aspects of the disclosure. In some implementations, one or more process blocks of FIG. 6 may be performed by one or more components of an SoC, such as processor(s), memory, or other circuitry, any or all of which may be means for performing the operations of process 600. For example, in some aspects, one or more process blocks of FIG. 6 may be performed by control circuitry for an SoC (e.g., SoC 300), such as the MPro 312, the GEM 307, etc. As shown in FIG. 6, process 600 may periodically perform an operation configuration, but in other aspects, the operation configuration may be performed in response to a trigger condition. Examples of trigger conditions include, but are not limited to, determining that a past, current, or anticipated future operation condition does not meet a performance requirement. In some aspects, the operation configuration is performed in response to a periodic trigger, such as a timer that wakes up at a fixed period from an external clock, for example. In the example shown in FIG. 6, an operation configuration includes the following steps.

Process 600 may include, at block 610, determining a processor core utilization in a many-core system. In some aspects, the operation of block 610 may be performed by the MPro 312, e.g., based on performance data provided to it by the GEM 307 of each core 302. In some aspects, the performance data received from each core 302 is stored in MPro memory 326 and analyzed by MPro firmware 328 to determine the processor core utilization of the SoC 300. In some aspects, determining the processor core utilization in the many-core system comprises determining a number of processor cores that have an activity level that exceeds an activity threshold. In some aspects, the activity level is based on at least one of: a number of instructions per second (IPS); a number of active processes; a workload classification; a performance indicator; or a runtime counter value. In some aspects, the performance indicator comprises at least one of: a count of instructions per cycle (IPC); a count of memory accesses; a count of branch hits or misses; a count of translation look-aside buffer (TLB) hits or misses; a count of cache hits or misses; a ratio of cache misses to memory accesses; a ratio of L2 data cache refills to cache misses; or a ratio of L2 instruction cache refills to branch misses.

Process 600 may further include, at block 620, determining an operation configuration based on the processor core utilization. In some aspects, the operation of block 620 may be performed by the MPro firmware 328. In some aspects, the MPro 312 may determine an operation configuration using an artificial intelligence (AI) or machine learning (ML) model. In some aspects, the operation of block 620 may be performed by the PMU 304. In some aspects, the operation of block 620 may be performed by the IDR 400, e.g., based on information collected by the PMU 304 and provided to the IDR 400. In some aspects, determining the operation configuration comprises determining at least one of a prefetch configuration, a branch architecture configuration, or a microarchitecture configuration. In some aspects, determining a microarchitecture configuration comprises determining at least one of a dispatch width or a size of a front-end queue (FEQ).

Referring to FIG. 4 for example, in some aspects, during operation of the core 302, the PMU 304 monitors PMU data 412 from the schedulers and provides PMU or other information 414 to the IDR 400. In some aspects, the IDR 400 uses this information 414 to determine when an application exhibits a low instructions per cycle (IPC) region and identify times when partition P1 could be disabled or powered down without performance loss, e.g., such as when a bottleneck is somewhere downstream rather than in UOP execution. This results in only one partition (i.e., P0) being used instead of both P0 and P1, and is thus referred to herein as “half-width dispatch” mode. When both partitions are active, this is referred to herein as “full-width dispatch” mode.

In some aspects, the low IPC regions may be identified using issue counts. In some aspects dispatch width can be adjusted based on an observed rate of issue (number of UOPs issued/cycles). For example, the IDR 400 can determine how many integer UOPs were issued by the IXU 402 during one epoch (N cycles, e.g., N=32, 64, 28, 256, . . . ), and if that integer UOP issue rate is below a threshold rate, referred to herein as an integer UOP watermark, then the IDR 400 can stop sending integer UOPs to the P1 partition of the IXU 402. The now-idle P1 partition of the IXU 402 can then be de-clocked or powered down. Likewise, the IDR 400 can determine how many floating point UOPs were issued by the FSU 404 during the epoch, and if the floating point UOP issue rate is below a floating point UOP watermark (which may be independent from the integer UOP watermark), the IDR 400 can stop sending floating point UOPs to the P1 partition of the FSU 404. The now-idle P1 partition of the FSU 404 can then be de-clocked or powered down. The actions of idling, de-clocking, or powering down a partition may be referred to herein as “throttling” the partition.

In some aspects, only the P1 partition is throttled and partition P0 is never throttled, i.e., full-width dispatch uses both partitions and half-width dispatch uses partition P0. In some aspects, the IXU 402 and FSU 404 are set to half-width or full-width dispatch independently. In some aspects, the IXU 402 and FSU 404 are always the same as each other, i.e., both are full-width or both are half-width. For example, in some aspects, both the IXU 402 and FSU 404 are set to half-width mode only when both the integer UOP issue rate and the floating point UOP issue rate are below their respective benchmarks, and in other aspects, both the IXU 402 and FSU 404 are set to half-width mode when either the integer UOP issue rate or the floating point UOP issue rate is below its respective benchmarks, even if the other issue rate is above its respective benchmark. In some aspects, each of the IXU 402 and the FSU 404 may maintain one or more counters for measuring how many UOPs are issued per epoch. In some aspects, this rate information is provided to the IDR 400 via the PMU 304, and the IDR 400 initiates the change of mode from full-width dispatch to half-width dispatch or vice versa. In some aspects, the watermark(s), epoch duration, or other parameters may be programmable and may be changeable during runtime via the GEM 307. The examples are illustrative and not limiting.

In some aspects, determining the operation configuration comprises determining the operation configuration using a trained machine learning (ML) model instantiated in hardware, a firmware layer, an operating system layer, an application layer, or a combination thereof. In some aspects, the ML model comprises a decision tree, a neural network, a Vowpal's wabbit, a contextual bandit, a Bayes classifier, a linear classifier, a component analyzer, a transformer, or a combination thereof. In some aspects, the process 600 further comprises training the ML model prior to its use.

Process 600 may further include, at block 630, configuring at least one processor core in the many-core system according to the operation configuration. In some aspects, the operation of block 630 may be performed by the MPro 312. For example, in some aspects, the MPro 312 can determine an optimal operation configuration for one or more of the cores 302 and send configuration instructions to the MSR 306 of one or more of the cores 302. In some aspects, the MSR 306 of a core 302 can be used to set or change an integer UOP threshold used by the IXU 402, a floating point UOP threshold used by the FSU 404, or other parameter used by any component of the core 302. In some aspects, configuring the at least one processor core in the many-core system according to the operation configuration comprises writing register settings to at least one control register of the at least one processor core in the many-core system. In some aspects, configuring the at least one processor core in the many-core system according to the operation configuration comprises writing register settings to at least one control register of at least one other processor core in the many-core system.

Process 600 may include additional implementations, such as any single implementation or any combination of implementations described below and/or in connection with one or more other processes described elsewhere herein. In some aspects, the prefetch configuration operation may be performed for at least one other processor core, a subset of all the processor cores, or all of the processor cores, in the many-core system. Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Runtime adaptive operation configuration in a many-core system provides a number of technical advantages, including but not limited to the following. Runtime adaptive operation configuration can be performed in response to ever-changing workload conditions and may be performed as often or as rarely as needed. This obviates the need for the customer to know which prefetcher configuration to use for the target customer workload. A ML model can be trained to determine the best prefetching configuration from all or a subset of possible prefetching configurations, using all or some minimum subset of performance indicators, and this training can be done once offline (i.e., in a training system), after which the trained ML model can be instantiated wherever and whenever needed and used online (i.e., in a customer-accessible system). Moreover, the operation of the runtime adaptive operation configuration algorithm may be controlled or modified by the customer, including disabling runtime adaptive operation configuration entirely, e.g., via a BIOS setting. The techniques disclosed herein have been proven to increase performance of a many-core processor and may also be applied to other aspects of the operation of a many-core system to provide other benefits, such as reducing power consumption.

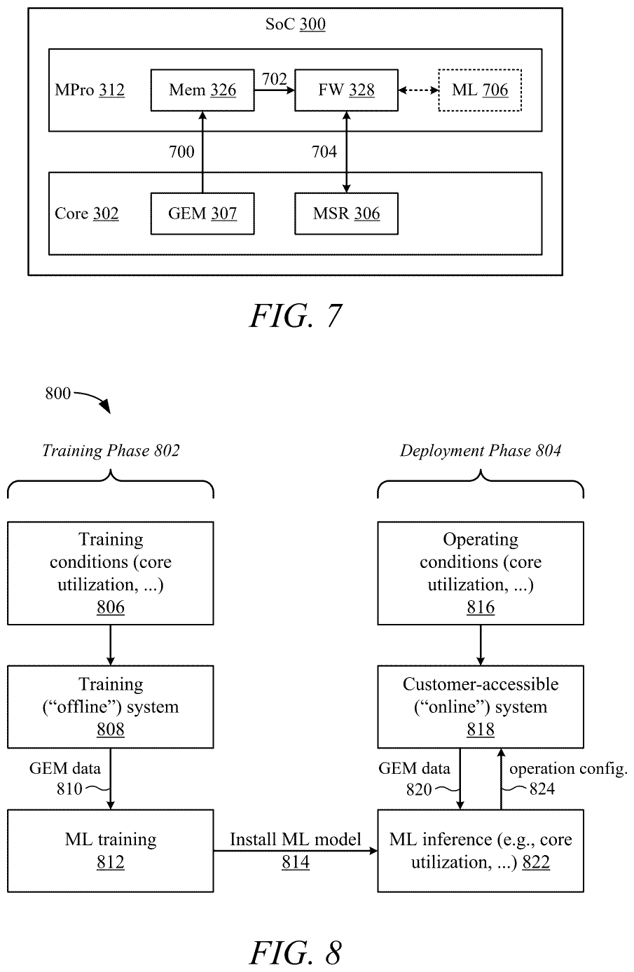

FIG. 7 is a diagram 700 illustrating runtime adaptive operation configuration in a many-core system, according to aspects of the disclosure. FIG. 7 illustrates an interaction between a core 302 and an MPro 312 within a SoC 300, with the mesh interconnect 310 and other circuitry omitted for clarity. In the example shown in FIG. 7, a GEM 307 within the core 302 provides collected data to the MPro 312, e.g., by writing it to the MPro memory 326 (event 700). For example, in one aspect the SoC 300 may have 192 cores 302 and each GEM 307 has 8 counters that can select from 16 different events that are 4 bytes each. In this example, the memory 326 may have a buffer size of 192*8*4 bytes, or 6,144 bytes in which to store data from the various GEMs 307 within the SoC 300, which the firmware 328 reads and aggregates. In the example shown in FIG. 7, the MPro firmware 328 reads the data from the memory 326 (event 702) and processes it to determine an optimal operation configuration for that core 302 based at least in part on core utilization. The firmware 328 may then update the MSR 306 of the core 302 (event 704) to put the core 302 into the optimal operation configuration.

In some aspects, the firmware 328 may use an ML model 706 to determine the optimal operation configuration. In some aspects, the ML model 706 may comprise a decision tree or other type of machine learning classifier algorithm that shows a pathway or hierarchical structure to a decision or an output. A decision tree may be used for both classification and regression tasks, and for decision making. It consists of a root node, branches, and leaf nodes, which display the possible choices and outcomes based on a series of problems or inputs. In some aspects, a single decision tree is trained. In some aspects, multiple decision trees are trained. In some aspects, other data mining algorithms that are commonly used in classification and supervised learning may be used instead of a decision tree. Examples of such algorithms include but are not limited to: Hoeffding trees (streaming data algorithm); random forests (multi decision tree plus voting to reduce overfitting); a perceptron (single level neural network, easy to build in hardware); Vowpal's wabbit; contextual bandits; parametric naïve Bayes classification (NBC); neighborhood components analysis (NCA); multinomial logistic regression; and support vector machines (SVM). Like decision trees, these can also be embodied in hardware.

The example shown in FIG. 7 is illustrative and not limiting. In some aspects, a different ML model 706 could be trained and deployed for each of different ranges of core utilization, where are referred to herein as intervals, allowing the correct choice of operation configuration for each utilization level in the SoC system. In some aspects, a single ML model 706 could be trained and allow inference at any core count, which can reduce firmware memory consumption. In some aspects, a core with fewer than 1,000,000 instructions retired during a 100 ms time epoch are considered to be inactive, and this criteria may be used to determine the core utilization. In some aspects, an ML model 706 may be trained at all of the core counts. In some aspects, multiple ML models 706 may be combined to make an aggregate model that can be inferred quickly without losing fidelity or accuracy. In some aspects, based on how many cores are active, the ML model(s) 706 may be queried with the runtime counters, and the ML model(s) 706 decide the optimal operation configuration to assert. In some aspects, prefetchers may be dynamically enabled or disabled based on a current core utilization. In some aspects, a branch prediction algorithm may be selected based on a current core utilization. In some aspects, other configurations, and combinations of configurations, may be selected based on a current core utilization. In some aspects, a kernel module may query the ML model 706. In some aspects, the ML model 706 may be accessed by firmware via a sideband firmware interface. In some aspects, the ML model 706 may be updated during runtime. In some aspects, the ML model 706 may be updated during system operating system, software, and/or firmware updates. In some aspects, another type of circuit may be used in place of the ML model 706 in FIG. 7.

FIG. 8 is a flow chart illustrating a process 800 for runtime adaptive operation configuration in a many-core system, according to aspects of the disclosure. In the example shown in FIG. 8, process 800 includes a training phase 802 followed by a deployment phase 804. In the example shown in FIG. 8, the training phase 802 comprises providing a training workload 806 to a training (“offline”) system 808 and using GEM data 810 that is collected periodically during execution of the training conditions 806 for ML training 812. The training conditions include scenarios with different core utilizations, and may also include different workloads, phases, etc. The frequency at which the GEM data 810 is collected and analyzed by an ML model, such as the ML model 706 in FIG. 7—an operation that may be referred to herein as “utilization detection”—may be adjusted as well. In one implementation, for example, a period for utilization detection was set to 100 milliseconds, based on context switch times in modern operating systems. As used herein, the 100 ms period is also referred to as the “epoch.” During training, performance data may be collected at a fine granularity for training purposes, e.g., at a finer granularity than may ultimately be necessary for runtime operation.

In some aspects, the data that is used to train the ML model to identify the core utilization may also be used to train the ML model to also detect “phases” of program behavior, where a “phase” is a pattern of operation, which may be from the viewpoint of memory access. In some aspects, a defined phase may be identified based on PMU values.)

In some aspects, specific core utilization values and workload sets are selected for training, e.g., to ensure that a wide range of potential core utilization and customer workload scenarios are considered during ML training 812, to fine tune the ML model to specific core utilizations and workloads that a customer is likely to run, or a combination thereof. After the ML has been trained, the ML is installed (block 814). In some aspects, the trained ML model is installed onto the firmware of the target system, which is then put into operation.

In the example shown in FIG. 8, the deployment phase 804 comprises providing operating conditions 816 to a customer-accessible (“online”) system 818 in which the trained ML model has been installed. GEM data 820 collected during execution of the operating conditions 816 are provided to the ML model operating in inference mode 822, and the ML model provides an operation configuration 824 (e.g., register settings) to the customer-accessible system 818. In some aspects, the customer-accessible system 818 periodically queries the ML model to notify the customer-accessible system 818 which operation configuration to use based on the current core utilization identified in real time. Examples of register settings that can be changed may include, but are not limited to: the mix of prefetchers that are activated or deactivated; the mix of cores to which the prefetcher configuration is to be applied; the periodicity of the phase detection; and so on.

In some aspects, the operation configuration selected or output by the ML model may be applied only to the particular core which provided the GEM data. In these implementations, each processor core may have its own independent operation configuration. In some aspects, the operation configuration selected or output by the ML model may be presumed to apply to all processor cores in the many-core system. In some aspects, one subset of processor cores in the many-core system may have an operation configuration that is different from other processor cores, or other subsets of processor cores, in the many-core system. In some aspects, the GEM data used by the ML model to select or output an operation configuration may represent performance data across all processor cores in the many-core system.

In some aspects, the input to algorithm is more than just core utilization. For example, the phase of a workload running on the core may also be considered during the operation configuration selection process. In some aspects, the phase of the workload may be derived from IPC values. It will be understood that metrics other than IPC, or combinations of metrics that may include IPC, may be used to identify or distinguish different phases. In some aspects, during training of the ML model 706, each defined phase may be found to benefit from a particular operation configuration. Thus, in some aspects, the ML model 706 may determine the phase (e.g., one of I-VIII in FIG. 1) that most closely represents the current behavior of the core, based on the most recent GEM data, and output one or more register settings to configure the core to the desired operation configuration.

During offline classification, for example, in some aspects, different performance monitoring counters may be used to identify workload phases, to see which counter or combination of counters best identifies (or distinguishes between) workload phases. For example, in one implementation, it was determined that good phase delineation was achieved using only counters that indicate cache hit/miss events, counters that indicate prefetch launch events, and counters that indicate IPC. While other counters, such as counters for branch misprediction, TLB miss, store-to-load forwarding mispredicts, and program execution level changes could be used instead of (or in addition to) the first set of counters described above, it was determined that the addition of those counters did not provide a benefit that justified the additional complexity, time, or cost. For example, many counters may not show any correlation to changing the operation configuration and so it would be a waste to consider those counters during phase classification.

Alternatives to hardware counters include sampling program counters or tracking instruction types. In some aspects, similar PCs can be clustered together into phases. Yet another metric is to track instructions, i.e., to count the number of certain types of instructions executed in an epoch and to use the counts per instruction type as signatures, where similar signatures are grouped together into a single phase.

During online detection, on the other hand, phase detection tends to be limited by the number of hardware counters available on the system. For example, in one implementation, three programmable hardware counters (branch misses, cache misses, and memory accesses) are used. There is a tradeoff between using more counters, which may improve phase detection accuracy but reduce counters available for use by any other processes, and using fewer counters, which provides more counters for other processes but may result in less accurate phase detection.

There are some workloads which may bounce back and forth between different optimum operation configurations at high frequency, sometimes at every epoch. Thus, in some aspects, it may be useful to allow for some amount of hysteresis in the runtime adaptive operation configuration process. For example, in some aspects, an operation configuration may be changed only if the ML model recommends the same configuration—different from the current configuration—for some number (e.g., 2 or 3) of epochs in a row. It is understood that the same epoch length should be used for both offline training and online classification.

As a general case, there are a number of performance metrics that may be used as inputs to a machine learning model. A PMU 304 is typically a set of hardware registers that keep track of how many times a specific type of event occurs during a given timeframe. As such, a PMU 304 typically consumes one of a limited number of hardware counters on the core 302 for each type of event that is being monitored. For a specific implementation of runtime adaptive operation configuration, it may be that only certain types of events are useful to differentiate between program behaviors sufficiently enough to determine that a change to a current operation configuration is warranted. Thus, in some aspects, there may be a process to determine which types of GEM data should be provided to the ML model and which should not, with the goal to determine the minimum number of PMU registers or hardware counters necessary for this purpose, in order to not consume more of them than needed so that they are available for other uses. For example, in one implementation, a PMU 304 has ten counters, and it was determined that just three types of GEM data were sufficient to properly identify the current program phase and adjust the operation configuration accordingly (e.g., by indexing into the decision tree model).

Likewise, as a general case, there may be many different operation configurations available in hardware. To use prefetch configurations as an example, an exemplary core may have four different prefetchers in the level 2 cache (L2C) subsystem: a best offset prefetcher (BOP), which is aggressive and accurate; a second-best offset prefetcher (SBOP), which requires the BOP to also be active; a spatial prefetcher (SPP), which performs adjacent (i.e., odd or even) sector prefetch; and a next line prefetcher (NLP). Because the SBOP requires the BOP to also be active, but otherwise each prefetcher may be activated or deactivated independently, there are twelve possible combinations, including all prefetchers being off. For a specific implementation, it may be determined that only some of those twelve possible combinations are sufficiently effective to justify a reconfiguration during runtime. For example, in one implementation, it was determined that only five prefetcher configurations were needed—namely, BOP+SPP, BOP+SBOP, SPP+NLP, all ON, and all OFF. Thus, in some aspects, there may be a process to determine which of the possible prefetcher configurations should be recommended by the ML model and which should not, with the goal to reduce the complexity of the decision process by limiting the number of possible outcomes that must be evaluated.

Also, as a general case, there are a number of possible ways to characterize the behavior of a process based on the PMU(s) values. For example, a process may be characterized as memory intensive if the memory accesses metric exceeds a threshold, or as process intensive if the IPC value exceeds another threshold, and so on. Thus, for a specific implementation, there may be a process to determine how best to characterize behavior of processes running on a core 302.

In one implementation, for example, it was determined that an optimal result was achieved when only a single decision tree was used rather than multiple decision trees and when only five of the twelve possible prefetcher configurations were considered as target outputs by the ML model 706. In one implementation, for example, a frequency for phase detection was set to 10 Hz, based on context switch times in modern operating systems.

It will be understood that the example above is also illustrative and not limiting. For other systems, which may have different hardware and which may have different customer workloads, a different set of design decisions may provide the optimal result. For example, in some aspects, a kernel module coordinates the interaction with the trained ML module, but in alternative aspects, the trained ML module may be accessed via a sideband firmware interface. In some aspects, runtime adaptive operation configuration may be an optional feature, e.g., enabled or disabled through BIOS controls.

It will also be understood that the techniques for determining an optimal operation configuration may also be applied to optimize the performance of other behaviors that are controllable by register settings that can be changed from outside of the system. Examples of other configurations that could benefit from phase detection and analysis by a trained ML model to improve performance include but are not limited to: allocating all fill buffers for possible prefetches, or only allocating some fill buffers for prefetches and sequestering and dedicating the rest for demand accesses; enabling or disabling a processor core's code prefetcher; and enabling “near atomics” versus “far atomics” for synchronization primitives and lock elision. Examples for saving power include but are not limited to: changing memory control page-open and page-closed policies, for determining how long to keep pages open; activating or deactivating a core's ability to reduce the instruction decode width, to provide opportunity to shut off some portion of the out-of-order subsystem; activating or deactivating a processor core's ability to disable half of the floating-point hardware when there are very few floating-point instructions seen in recent code; and activating or deactivating half-width dispatch. Like prefetcher configurations, these configuration changes can also be made by a ML model, based on the current program or workload phase or other metrics.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium or non-transitory storage media known in the art. An exemplary storage medium is coupled to the processor such that the processor can read information from, and write information to, the storage medium. In the alternative, the storage medium may be integral to the processor. The processor and the storage medium may reside in an ASIC.

Thus, the various aspects described herein may be embodied in a number of different forms, all of which are within the scope of the claimed subject matter. In addition, for each of the aspects described herein, the corresponding form of any such aspects may be described herein as, for example, “logic configured to,” “instructions that when executed perform,” “computer instructions to,” and/or other structural components configured to perform the described action.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for runtime adaptive operation configuration in a many-core system, the method comprising:
performing an operation configuration comprising:
determining a processor core utilization in the many-core system;
determining an operation configuration based on the processor core utilization; and
configuring at least one processor core in the many-core system according to the operation configuration.

2. The method of claim 1, wherein determining the processor core utilization in the many-core system comprises determining a number of processor cores that have an activity level that exceeds an activity threshold.

3. The method of claim 2, wherein the activity level is based on at least one of:
a number of instructions per second (IPS);
a number of active processes;
a workload classification;
a performance indicator; or
a runtime counter value.

4. The method of claim 3, wherein the performance indicator comprises at least one of:
a count of instructions per cycle (IPC);
a count of memory accesses;
a count of branch hits or misses;
a count of translation look-aside buffer (TLB) hits or misses;
a count of cache hits or misses;
a ratio of cache misses to memory accesses;
a ratio of L2 data cache refills to cache misses; or
a ratio of L2 instruction cache refills to branch misses.

5. The method of claim 1, wherein determining the operation configuration comprises determining at least one of:
a prefetch configuration;
a branch architecture configuration; or
a microarchitecture configuration.

6. The method of claim 5, wherein determining the microarchitecture configuration comprises determining at least one of:
a dispatch width; or
a size of a front-end queue (FEQ).

7. The method of claim 1, wherein determining the operation configuration comprises determining the operation configuration using a trained machine learning (ML) model instantiated in hardware, a firmware layer, an operating system layer, an application layer, or a combination thereof.

8. The method of claim 7, wherein the ML model comprises a decision tree, a neural network, a Vowpal's wabbit, a contextual bandit, a Bayes classifier, a linear classifier, a component analyzer, a transformer, or a combination thereof.

9. The method of claim 7, further comprising training the ML model prior to its use.

10. The method of claim 1, wherein configuring the at least one processor core in the many-core system according to the operation configuration comprises writing register settings to at least one control register of the at least one processor core in the many-core system.

11. The method of claim 1, wherein configuring the at least one processor core in the many-core system according to the operation configuration comprises writing register settings to at least one control register of at least one other processor core in the many-core system.

12. The method of claim 1, wherein the operation configuration is performed periodically or in response to a trigger condition.

13. An apparatus for runtime adaptive operation configuration in a many-core system, the apparatus comprising:
a plurality of processor cores; and
control circuitry coupled to the plurality of processor cores and configured to perform an operation configuration comprising:
determining a processor core utilization in the many-core system;
determining an operation configuration based on the processor core utilization; and
configuring at least one processor core of the plurality of processor cores according to the operation configuration.

14. The apparatus of claim 13, wherein, to determine the processor core utilization in the many-core system, the control circuitry is configured to determine a number of processor cores of the plurality of processor cores that have an activity level that exceeds an activity threshold.

15. The apparatus of claim 14, wherein the activity level is based on at least one of:
a number of instructions per second (IPS);
a number of active processes;
a workload classification;
a performance indicator; or
a runtime counter value.

16. The apparatus of claim 15, wherein the performance indicator comprises at least one of:
a count of instructions per cycle (IPC);
a count of memory accesses;
a count of branch hits or misses;
a count of translation look-aside buffer (TLB) hits or misses;
a count of cache hits or misses;
a ratio of cache misses to memory accesses;
a ratio of L2 data cache refills to cache misses; or
a ratio of L2 instruction cache refills to branch misses.

17. The apparatus of claim 13, wherein, to determine the operation configuration, the control circuitry is configured to determine at least one of:
a prefetch configuration;
a branch architecture configuration; or
a microarchitecture configuration.

18. The apparatus of claim 17, wherein, to determine the microarchitecture configuration, the control circuitry is configured to determine at least one of:
a dispatch width; or
a size of a front-end queue (FEQ).

19. The apparatus of claim 13, wherein, to determine the operation configuration, the control circuitry is configured to determine the operation configuration using a trained machine learning (ML) model instantiated in hardware, a firmware layer, an operating system layer, an application layer, or a combination thereof.

20. The apparatus of claim 19, wherein the ML model comprises a decision tree, a neural network, a Vowpal's wabbit, a contextual bandit, a Bayes classifier, a linear classifier, a component analyzer, a transformer, or a combination thereof.

21. The apparatus of claim 19, wherein the control circuitry is further configured to train the ML model prior to its use.

22. The apparatus of claim 13, wherein, to configure the at least one processor core of the plurality of processor cores according to the operation configuration, the control circuitry is configured to write register settings to at least one control register of the at least one processor core of the plurality of processor cores.

23. The apparatus of claim 13, wherein, to configure the at least one processor core of the plurality of processor cores according to the operation configuration, the control circuitry is configured to write register settings to at least one control register of at least one other processor core of the plurality of processor cores.

24. The apparatus of claim 13, wherein the control circuitry is configured to perform the operation configuration periodically or in response to a trigger condition.

25. An apparatus, comprising:
means for performing an operation configuration, comprising:
means for determining a processor core utilization in a many-core system;
means for determining an operation configuration based on the processor core utilization; and
means for configuring at least one processor core in the many-core system according to the operation configuration.

26. A non-transitory computer-readable medium storing computer-executable instructions that, when executed by an apparatus, cause the apparatus to perform an operation configuration, the computer-executable instructions comprising:
computer-executable instructions that, when executed by the apparatus, cause the apparatus to determine a processor core utilization in a many-core system;
computer-executable instructions that, when executed by the apparatus, cause the apparatus to determine an operation configuration based on the processor core utilization; and
computer-executable instructions that, when executed by the apparatus, cause the apparatus to configure at least one processor core in the many-core system according to the operation configuration.
